(19) United States
(12) Patent Application Publication
(10) Pub. No.: US 2026/0107879 A1
(43) Pub. Date: Apr. 23, 2026

(54) RADAR SUPPORT STRUCTURE FOR SUGARCANE HARVESTER

(71) Applicant: DEERE & COMPANY, Moline, IL (US)

(72) Inventors: SURFRAJ FATTEPUR, Pune (IN); ERIC P. RICHARD, Thibodaux, LA (US); JOHN A. DIGHTON, Napoleonville, LA (US)

(21) Appl. No.: 19/195,860

(22) Filed: May 1, 2025

Related U.S. Application Data
(60) Provisional application No. 63/710,104, filed on Oct. 22, 2024.

(51) Int. Cl. A01D 45/10; A01D 23/04; A01D 41/127

(52) U.S. Cl. CPC A01D 45/10; A01D 23/04; A01D 41/127

(57) ABSTRACT

A sugarcane harvester includes a topper assembly having a boom that is mounted to a main frame. A radar support structure includes a cantilevered portion having a first end attached to the main frame and extending generally horizontally in the forward direction to a second end. The cantilevered portion is laterally offset from the boom, and is attached to the main frame at approximately the same elevation as the boom. The radar support structure includes a drop portion having an upper end attached to the second end of the cantilevered portion and extending generally vertically in a downward direction toward the ground surface to a lower end. A radar sensor assembly is attached to the lower end of the drop portion of the radar support structure.

### CROSS-REFERENCE TO RELATED APPLICATIONS

This application claims the benefit of U.S. Provisional Patent Application Ser. No. 63/710,104, filed on Oct. 22, 2024, the disclosure of which is hereby incorporated by reference.

### TECHNICAL FIELD

The disclosure generally relates to a sugarcane harvester.

### BACKGROUND

When harvesting sugarcane, it is generally desirable to cut the sugarcane crop at a location spaced above the ground surface. Under some conditions, productivity and quality losses occur when crop is cut at or below the ground surface. However, if the sugarcane is cut a location too far above the ground surface, some of the valuable crop can be lost.

In crop harvesting of sugarcane, it is desirable to cut the sugarcane at a consistent distance at each sugarcane stalk spaced with respect to the ground surface. The cutting tools, however, are obscured by the crop so visual feedback is limited. In the sugarcane crop, particularly since the stalk includes desirable material, cutting the stalk closer to the ground, but not too close to ingest soil, is preferred.

Radar sensors may be used to detect the ground surface, and a controller of a sugarcane harvester may adjust the height of a basecutter assembly based on the elevation of the ground surface to achieve the desired cut height. However, in order to do so, the radar sensor must be positioned forward of the basecutter, which is generally in the flow in incoming crop material to be harvested. Accordingly, it is desirable to mount the radar sensor in a manner that enables the radar sensor to detect the ground surface while minimizing interfering with incoming crop material.

### SUMMARY

A sugarcane harvester is provided. The sugarcane harvester includes a main frame that extends along a central longitudinal axis between a forward end and a rearward end. A basecutter assembly includes a cutter blade that is configured to sever a sugarcane stalk portion of a sugarcane plant from a root portion of the sugarcane plant adjacent a ground surface. A topper assembly includes a boom that is mounted to the main frame, and a top cutter that is attached to and supported by the boom proximate a distal end of the boom. The top cutter is positioned for severing an upper leaf portion of the sugarcane plant from the stalk portion of the sugarcane plant. A radar support structure includes a cantilevered portion having a first end attached to the main frame and extending generally horizontally in the forward direction to a second end. The radar support structure includes a drop portion having an upper end attached to the second end of the cantilevered portion and extending generally vertically in a downward direction toward the ground surface to a lower end. A radar sensor assembly is attached to the lower end of the drop portion of the radar support structure, and is positioned forward of the basecutter assembly.

In one aspect of the disclosure, the cantilevered portion of the radar support structure is laterally offset from the boom of the topper assembly relative to the central longitudinal axis of the main frame. Because the cantilevered portion of the radar support structure is laterally offset from the boom, the first end of the cantilevered portion of the radar support structure and a mounting end of the boom may be positioned at approximately the same elevation relative to the ground surface. This enables the cantilevered portion of the radar support structure to be positioned higher above the ground surface, whereby the cantilevered portion of the radar assembly is positioned to not interfere with incoming stalk portions of the sugarcane plant processed during harvest operations.

In one aspect of the disclosure, the drop portion of the radar support structure positions the radar sensor assembly directly below the boom of the topper assembly in-line with the central longitudinal axis of the frame. As such, the drop portion of the radar support structure may have and/or present and inboard or inward bend, angle, or curvature to transition the drop portion from being laterally offset at the upper end of the drop portion to being nearer the central longitudinal axis of the frame at the lower end of the drop portion. This enables the drop portion to position the radar sensor assembly in-line with the central longitudinal axis of the frame, which may be generally above a row of sugarcane plants to be harvested.

In one aspect of the disclosure, the boom may be moveable in a vertical direction relative to the cantilevered portion of the radar support structure through a range of motion between a lower elevation limit and an upper elevation limit. Because the cantilevered portion of the radar support structure is laterally offset from the boom, the boom is free to move past and/or relative to the cantilevered portion without interference from the cantilevered portion of the radar support structure.

In one aspect of the disclosure, with the radar sensor assembly positioned directly below the boom, the sugarcane harvester may include a stop blocking movement of the boom in the vertical direction prior to contacting the radar sensor assembly. In one example implementation, the vertical position of the boom may be controlled by a double acting hydraulic cylinder, which is configured to retract to lower the boom. The stop may include a bracket partially encircling a rod of the hydraulic cylinder and preventing full retraction of the rod into a housing of the hydraulic cylinder, thereby limiting the stroke of the hydraulic cylinder and preventing the hydraulic cylinder from lowering the boom into contact with the radar sensor assembly.

In one aspect of the disclosure, the cantilevered portion of the radar support structure may include a first side cantilevered portion disposed on a first lateral side of the central longitudinal axis, and a second side cantilevered portion disposed on a second lateral side of the central longitudinal axis. The boom of the topper assembly may be disposed between and moveable relative to the first side cantilever portion and the second side cantilevered portion. Additionally, the drop portion of the radar support structure may include a first side drop portion disposed on the first lateral side of the central longitudinal axis, and a second side drop portion disposed on the second lateral side of the central longitudinal axis. The boom of the topper assembly may be disposed between and moveable relative to the first side drop portion and the second side drop portion.

In one aspect of the disclosure, the radar support structure may form a notch, aligned along the central longitudinal axis of the frame, with the boom positioned within the notch and with the radar sensor assembly positioned below the boom. In one example implementation, the notch is defined between the first side cantilevered portion and the first side drop portion on the first lateral side of the central longitudinal axis, and is defined by the second side cantilever portion and the second side drop portion on the second lateral side of the central longitudinal axis.

In one aspect of the disclosure, the boom may be moveable relative to the radar support structure through a range of motion between a lower elevation limit and an upper elevation limit. The boom may move vertically within the space between the first side cantilevered portion and the second side cantilevered portion, and within the space between the first side drop portion and the second side drop portion.

In one aspect of the disclosure, the first side drop portion and the second side drop portion of the radar support structure position the radar sensor assembly directly below the boom of the topper assembly, in-line with the central longitudinal axis of the frame.

In one aspect of the disclosure, the radar sensor assembly is configured for detecting data related to an elevation of the ground surface. The radar sensor assembly may include a transmitter for transmitting an electromagnetic wave, and a receiver for detecting a returned electromagnetic wave reflected from the ground surface.

In one aspect of the disclosure, the sugarcane harvester may include a controller including a processor and a memory having a basecutter control algorithm stored, thereon. The controller may be operable to execute the basecutter control algorithm to control a height of the basecutter assembly relative to the ground surface based on the data sensed by the radar sensor assembly.

Accordingly, the radar support structure is configured with the cantilevered portion disposed at the approximate elevation as the boom, relative to the ground surface, and includes the drop portion to position the radar sensor assembly at the desired elevation relative to the ground. This configuration removes the cantilevered portion from the space below the boom, and reduces interference with the crop material being harvested at the front of the sugarcane harvester.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a sugarcane harvester.

FIG. 2 is a schematic partial perspective view of the sugarcane harvester showing a radar support structure.

FIG. 3 is a schematic partial side view of the sugarcane harvester showing the radar support structure.

FIG. 4 is a schematic partial frontal view of the sugarcane harvester showing the radar support structure.

FIG. 5 is a schematic partial top view of the sugarcane harvester showing the radar support structure.

FIG. 6 is a schematic side view of a topper actuator of the sugarcane harvester, showing a stop for the topper actuator.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

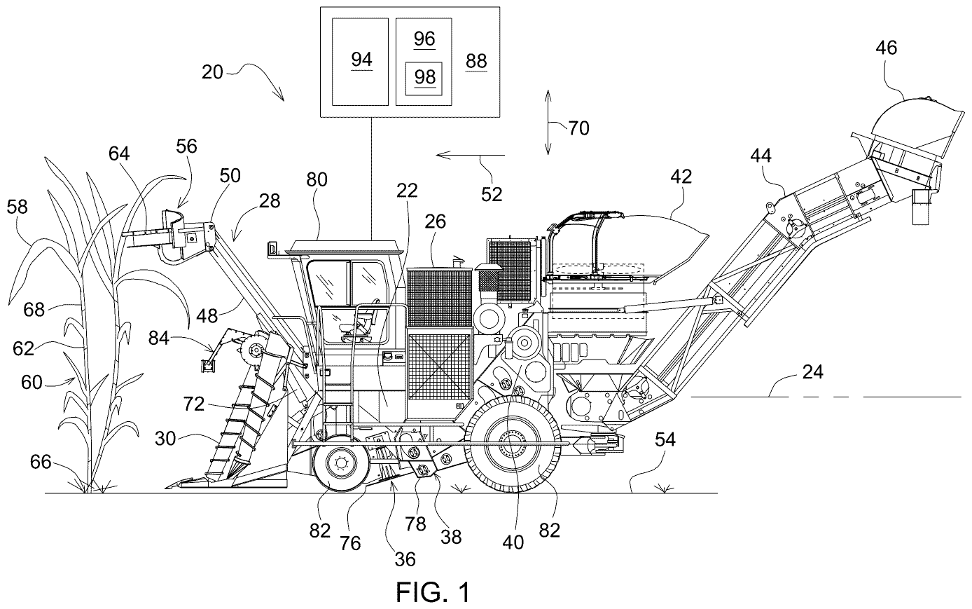

Referring to the Figures, wherein like numerals indicate like parts throughout the several views, a sugarcane harvester 20 is generally shown at 20. Referring to FIG. 1, the sugarcane harvester 20 includes a main frame 22, supporting various cutting, routing and processing devices. The main frame 22 extends along a central longitudinal axis 24, between a forward end and a rearward end, and may be considered the centerline of the sugarcane harvester 20. An engine 26 may supply power for driving the sugarcane harvester 20 and for powering various driven components of the sugarcane harvester 20. In certain embodiments, the engine 26 may directly power a main hydraulic pump (not shown). Various driven components of the sugarcane harvester 20 may be powered by hydraulic motors receiving hydraulic power from the main hydraulic pump via one or more hydraulic loops (not shown).

Referring to FIG. 1, among other components and features, some of which are not described herein, the sugarcane harvester 20 may include a topper assembly 28, a left and a right crop divider scroll 30, an upper knockdown roller 32 and a lower knockdown roller 34 (the upper and lower knockdown roller 34s are not shown), a basecutter assembly 36, a feed section 38, a chopping section 40, a primary extractor 42, an elevator 44, and a secondary extractor 46.

The topper assembly 28 is mounted to the main frame 22. The topper assembly 28 includes a boom 48 attached to the main frame 22. The boom 48 extends from the main frame 22 to a distal end 50 thereof, in a generally forward direction relative to a direction of travel 52 during harvest operation, and a generally upward direction relative to a ground surface 54. The topper assembly 28 includes a top cutter 56 attached to and supported by the boom 48 proximate the distal end 50 of the boom 48. The top cutter 56 is positioned for severing an upper leaf portion 58 of a sugarcane plant 60 from a central stalk portion 62 of the sugarcane plant 60. The top cutter 56 may include at least one topper blade 64 or other cutting device and/or system configured for cutting the sugarcane plant 60. The particular components, structure and operation of the top cutter 56 are understood by those skilled in the art, and are therefore not described in greater detail herein.

The sugarcane plant 60 may be defined to include a bottom root portion 66, the central stalk portion 62, and the upper leaf portion 58. The central stalk portion 62 of the sugarcane plant 60 is the desirable portion of the plant containing sugar. The central stalk portion 62 of the sugarcane plant 60 is severed from the bottom root portion 66 during harvest operations, thereby enabling the bottom root portion 66 of the sugarcane plant 60 to remain in the ground for regrowth the following growing season. The upper leaf portion 58 of the sugarcane plant 60 may be severed from the central stalk portion 62 and discarded prior to the sugarcane harvester 20 processing the central stalk portion 62 of the sugarcane plant 60 into billets. The central stalk portion 62 and the upper leaf portion 58 of the sugarcane plant 60 may be separated by a soft joint 68. The soft joint 68 of the sugarcane plant 60 is the portion of the sugarcane joint at which the upper leaves of the sugarcane plant 60 join the central stalk portion 62. Desirably, the top cutter 56 severs the sugarcane plant 60 at the soft joint 68, removing the upper leaf portion 58 of the sugarcane plant 60 so as not to be ingested into the sugarcane harvester 20, while retaining all of the central stalk portion 62 of the sugarcane plant 60 for processing into billets.

In order to account for the variation in height of the soft joint 68, and to sever the upper leaf portion 58 at the desired height above the ground surface 54, the boom 48 may be moveable relative to the main frame 22. The boom 48 may move through a range of motion along a vertical axis 70 between a lower elevation limit and an upper elevation limit. In order to move the boom 48, the topper assembly 28 may include a topper actuator 72. The topper actuator 72 is operable to move the top cutter 56 relative to the main frame 22 to thereby adjust a cut height of the top cutter 56 relative to the ground surface 54. The cut height may be defined as the vertical distance between the top cutter 56 and the ground surface 54. An operator and/or a controller 88 may control the topper actuator 72 to position the top cutter 56 at a cut height that approximates the soft joint 68 of the sugarcane plants 60. The topper actuator 72 may include, but is not limited to, hydraulic actuators, electrical actuators, control valves, linkage systems, etc., suitable for moving the boom 48 relative to the frame main. The particular components, structure and operation of the topper actuator 72 are understood by those skilled in the art, and are therefore not described in greater detail herein.

In one example implementation, the boom 48 is rotatably attached to the main frame 22 for rotation about a transverse axis 74 arranged perpendicular to the central longitudinal axis 24 of the main frame 22. The topper actuator 72 may extend to rotate the boom 48 about the transverse axis 74 in a first rotational direction to raise the distal end 50 of the boom 48, or may retract to rotate the boom 48 about the transverse axis 74 in a second rotational direction, opposite the first rotational direction, to lower the distal end 50 of the boom 48. It should be appreciated that the topper actuator 72 may be positioned and configured differently than the example implementation shown in the Figures and described herein.

The left and right crop divider scrolls 30 are adapted to lift the sugarcane for feeding into a throat of the sugarcane harvester 20. The upper and lower knockdown roller 34s are adapted to lean standing sugarcane plants 60 of crop material in the forward direction relative to the direction of travel 52 of the sugarcane harvester 20 during operation.

The basecutter assembly 36 is mounted to the main frame 22 adjacent the ground surface 54. The basecutter assembly 36 includes at least one cutter blade 76 configured to sever the sugarcane stalk portion of the sugarcane plant 60 from the root portion of the sugarcane plant 60 adjacent the ground surface 54. The basecutter assembly 36 is adapted to sever the sugarcane plants 60 knocked down or leaned over in the forward direction by the upper and lower knockdown roller 34s. Additionally, the basecutter assembly 36 is operable to move and/or feed the central stalk portion 62 of the sugarcane plant 60 to the feed section 38.

The feed section 38 is adapted to receive a mat of severed sugarcane crop material from the basecutter assembly 36, and to move the mat of crop material rearwardly for further processing. The feed section 38 may include, for example, successive pairs of upper and lower feed rollers 78 rotatably supported by the main frame 22. At least one pair of the upper and lower feed rollers 78 may be powered to transport the mat of the cut sugarcane crop material to the chopping section 40.

The chopping section 40 is adapted to receive the mat from the feed section 38 and to cut the sugarcane plant 60 into billets. The primary extractor 42 is positioned downstream from the chopping section 40 and is adapted to separate debris, including, for example, crop residue (e.g., leafy material), from the billets and remove the debris from the sugarcane harvester 20.

The elevator 44 is positioned at the rear of the sugarcane harvester 20 to receive the cleaned flow of billets, and is adapted to convey the billets to an elevated position where the billets are discharged into a transport vehicle to be hauled away. The secondary extractor 46 (some embodiments may not have a secondary extractor 46) is positioned near the top of the elevator 44, and is adapted to further separate debris from the billets and to remove the debris from the sugarcane harvester 20.

The sugarcane harvester 20 may include an operator station 80 and traction elements 82. The various user input and control devices, data output devices, etc., may be located within the operator station 80. A human operator may operate the sugarcane harvester 20 from the operator station 80. In certain embodiments, the main frame 22 may be supported by a transport frame such as track frame supporting the traction elements 82. The traction elements 82 are positioned on the left and right sides of the sugarcane harvester 20 for propelling the sugarcane harvester 20 through a field and along the ground surface 54. Each traction element may include, but are not limited to, a track unit or a ground-engaging wheel.

The sugarcane harvester 20 may include a radar support structure 84 that supports a radar sensor assembly 86. The radar sensor assembly 86 is configured for detecting data related to an elevation of the ground surface 54, and communicating the data to a controller 88. The radar sensor assembly 86 is substantially positioned centrally along the central longitudinal axis 24 of the of the main frame 22, e.g., the centerline of the sugarcane harvester 20, as it moves in the forward direction. The radar sensor assembly 86 is located in a forward position, in front of the basecutter assembly 36, but behind a front portion of the crop dividers. The radar sensor assembly 86 is used to identify the ground surface 54 elevation with respect to and in front of the basecutter assembly 36 based on a sensed ground plane. The ground plane is established by the ground surface 54. By imaging the ground surface 54 with radar signals transmitted by the radar sensor assembly 86, a leading signal for a control system is provided. The leading signal provides a forward looking sensing detection scheme to adjust the cutting height of the basecutter assembly 36 in anticipation of changes in the ground plane as the sugarcane harvester 20 moves forward. In one embodiment, the radar sensor assembly 86 is fixed at a predetermined position with respect to the frame. With the position of the radar sensor assembly 86 known relative to the main frame 22 and the basecutter assembly 36, a distance of the basecutter assembly 36 relative to the ground surface 54 is determinable.

The radar sensor assembly 86, and the processing system to which the radar sensor assembly 86 is connected, provides a non-contacting radar based ground detection system. The ground detection system provides a mechanism to automate a cutting height of the sugarcane plants 60 by adjusting the height of the basecutter assembly 36 and the blades thereof relative to the ground surface 54. Electromagnetic waves, i.e. signals, transmitted by the radar sensor assembly 86, penetrate obstructions between the sensor assembly and the ground surface 54, and provide an accurate determination of ground surface 54 location with respect to the basecutter assembly 36. The electromagnetic waves penetrate crop material, dust, water, fog, precipitation, any crop i.e., canopy, juice and residue. In addition, the radar sensor assembly 86 detects obstructions, such as rocks, located between the radar sensor assembly 86 and the ground surface 54. Electromagnetic waves include radio waves, microwaves, infrared waves, optical waves, ultraviolet waves, x-rays and gamma rays. As described herein, the radar assembly utilizes electromagnetic radio waves which are reflected from the ground and rocks, but which penetrate other materials thereby providing an accurate identification of the elevation of the ground surface 54.

The radar sensor assembly 86 may include a transmit antenna 92, i.e. transmitter 92, and a receive antenna 90, i.e. receiver 90. As the sugarcane harvester 20 moves in the forward direction when cutting sugarcane plants 60, the transmit antenna 92 transmits electromagnet waves from the radar sensor assembly 86 toward the ground and the receive antenna 90 receives reflected electromagnetic waves reflected from the ground surface 54 in response to the transmitted electromagnetic waves. Because the signal from the transmit antenna 92 is directed at location on the ground surface 54 located forward of the basecutter assembly 36, the radar sensor assembly 86 may be defined as forward looking, such that the ground level at a current location of the basecutter assembly 36 is detected and determined prior to the basecutter assembly 36 reaching that location on the ground surface 54.

In one implementation, the receive antenna 90 and the transmit antenna 92 may operate within a frequency range between 900 MHz to 24 GHz. In another implementation, the center frequency of the transmitted waves is approximately 7 GHz. Adjustable center frequencies are also contemplated. In one implementation, the radar sensor assembly 86 includes a synthetic aperture radar (SAR) array. The distance between the receive antenna 90 and transmit antenna 92 is based on the capabilities of different radar systems, is variable, and may include distances of between millimeters to meters.

The radar sensor assembly 86 provides a non-contact sensing system to measure the distance to the ground surface 54 for the sugarcane harvester 20. In one implementation, the distance of the ground surface 54 from the radar sensor assembly 86 is based on a period of elapsed time between transmission of the radar signal from the transmit antenna 92 to receipt of the reflected radar signal at the receive antenna 90. In another embodiment, the distance to the ground surface 54 is based on a phase shift between the transmitted signal and the received signal.

The controller 88 of the sugarcane harvester 20 may be configured to identify a distance between the basecutter assembly 36 and the ground surface 54. In one or more embodiments, the sensing radar system utilizes electromagnetic waves, which includes in different embodiments, the use of different types of radar sensors, to measure the distance from the radar sensor assembly 86 to the ground. Once the distance from the radar sensor assembly 86 to the ground is determined, the distance between the cutter assembly and ground surface 54 is determined. Using this determined distance, a cutting height of the cutter assembly is set to a preferred height.

The controller 88 is disposed in communication with the radar sensor assembly 86. The controller 88 is operable to receive data signals from the radar sensor assembly 86, and communicate a signal to control the cut height of the basecutter assembly 36. While the controller 88 is generally described herein as a singular device, it should be appreciated that the controller 88 may include multiple devices linked together to share and/or communicate information therebetween. Furthermore, it should be appreciated that the controller 88 may be located on the sugarcane harvester 20 or located remotely from the sugarcane harvester 20.

The controller 88 may alternatively be referred to as a computing device, a computer, a control unit, a control module, a module, etc. The controller 88 includes a processor 94, a memory 96, and all software, hardware, algorithms, connections, sensors, etc., necessary to manage and control the operation of the basecutter assembly 36. As such, a method may be embodied as a program or algorithm operable on the controller 88. It should be appreciated that the controller 88 may include any device capable of analyzing data from various sensors, comparing data, making decisions, and executing the required tasks.

As used herein, “controller 88” is intended to be used consistent with how the term is used by a person of skill in the art, and refers to a computing component with processing, memory, and communication capabilities, which is utilized to execute instructions (i.e., stored on the memory 96 or received via the communication capabilities) to control or communicate with one or more other components. In certain embodiments, the controller 88 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The controller 88 may be in communication with other components on the sugarcane harvester 20, such as hydraulic components, electrical components, and operator inputs within an operator station 80 of an associated work vehicle. The controller 88 may be electrically connected to these other components wirelessly or via a wiring harness such that messages, commands, and electrical power may be transmitted between the controller 88 and the other components. Although the controller 88 is referenced in the singular, in alternative embodiments the configuration and functionality described herein can be split across multiple devices using techniques known to a person of ordinary skill in the art.

The controller 88 may be embodied as one or multiple digital computers or host machines each having one or more processors 94, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 96 may include any non-transitory/tangible medium which participates in providing data or computer-readable instructions. The memory 96 may be non-volatile or volatile. Non-volatile media may include, for example, optical or magnetic disks and other persistent memory. Example volatile media may include dynamic random access memory (DRAM), which may constitute a main memory. Other examples of embodiments for memory 96 include a floppy, flexible disk, or hard disk, magnetic tape or other magnetic medium, a CD-ROM, DVD, and/or any other optical medium, as well as other possible memory devices such as flash memory.

The controller 88 includes the tangible, non-transitory memory 96 on which are recorded computer-executable instructions, including a basecutter control algorithm 98. The processor 94 of the controller 88 is configured for executing the basecutter control algorithm 98. The basecutter control algorithm 98 implements the method/process of sensing the elevation of the ground surface 54 with the radar sensor assembly 86 and controlling the cut height of the basecutter assembly 36 based on the sensed elevation of the ground surface 54, described above.

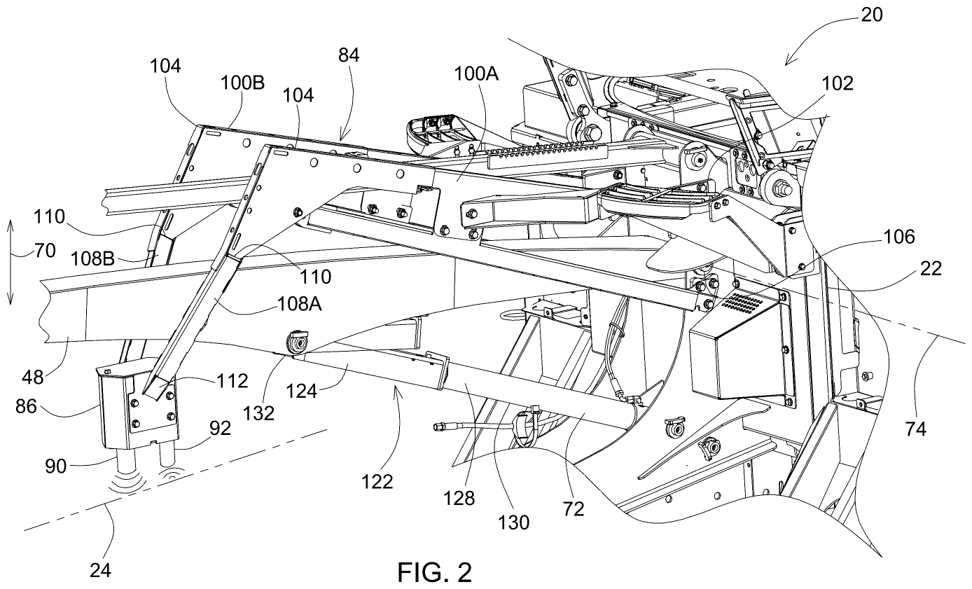

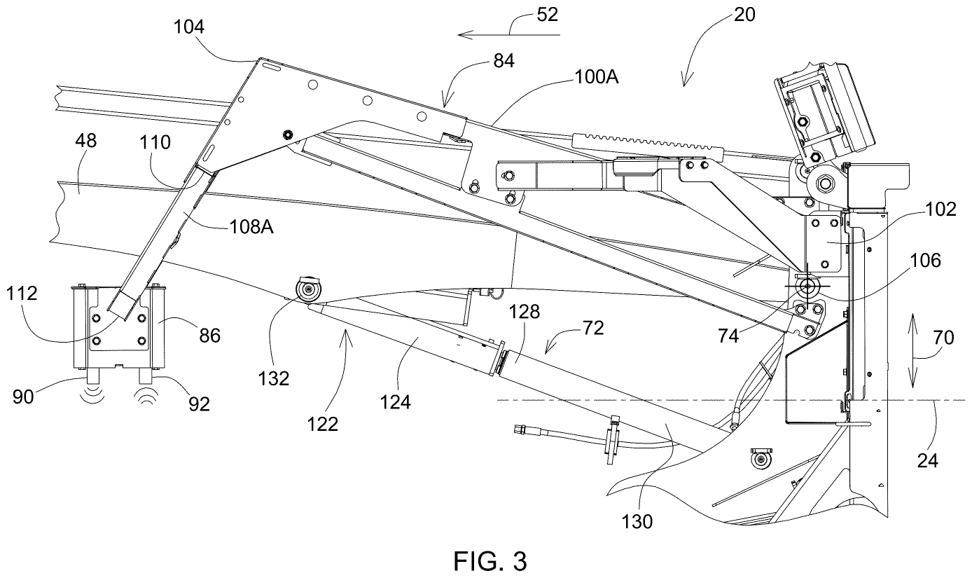

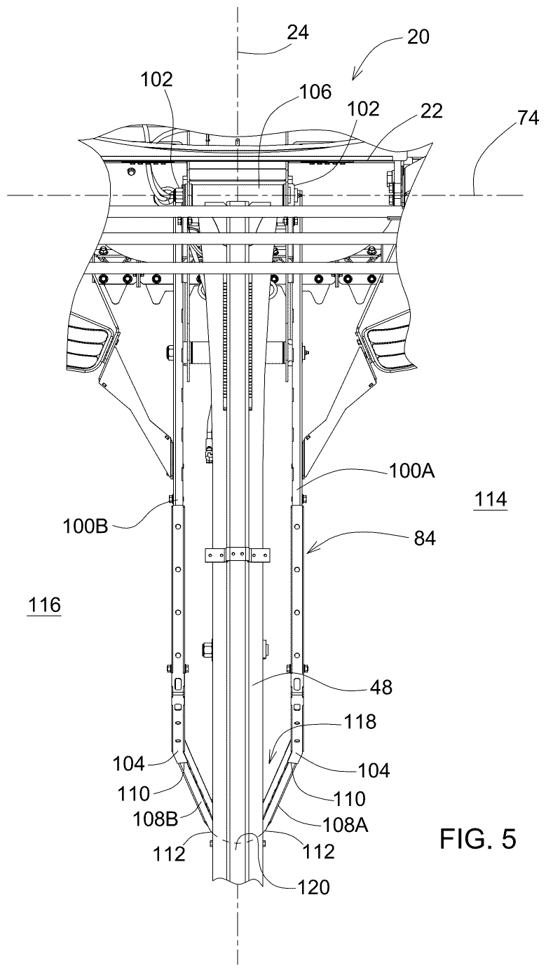

As noted above, the sugarcane harvester 20 includes the radar support structure 84 which supports the radar sensor assembly 86. Referring to FIGS. 2-5, the radar support structure 84 includes a cantilevered portion 100A, 100B having a first end 102 that is attached to the main frame 22. The cantilevered portion 100A, 100B of the radar support structure 84 extends from the first end 102 generally horizontally in the forward direction to a second end 104. The cantilevered portion 100A, 100B of the radar support structure 84 is laterally offset from the boom 48 of the topper assembly 28 relative to the central longitudinal axis 24 of the main frame 22. In other words, the cantilevered portion 100A, 100B of the radar support structure 84 is positioned outboard of the boom 48, i.e., nearer a lateral side of the sugarcane harvester 20 than the boom 48 relative to the central longitudinal axis 24 of the frame. Because the cantilevered portion 100A, 100B of the radar support structure 84 is laterally offset from the boom 48 relative to the central longitudinal axis 24 of the frame, the first end 102 of the cantilevered portion 100A, 100B of the radar support structure 84 and a mounting end 106 of the boom 48, i.e., the end of the boom 48 that is attached to the main frame 22, may be positioned at approximately the same elevation relative to the ground surface 54 without interfering with each other. In this position, the cantilevered portion 100A, 100B of the radar assembly is positioned to not interfere with or minimize interference with incoming stalk portions of the sugarcane plant 60.

The radar support structure 84 further includes a drop portion 108A, 108B having an upper end 110 attached to the second end 104 of the cantilevered portion 100A, 100B and extending generally vertically in a downward direction along the vertical axis 70 toward the ground surface 54 to a lower end 112. The radar sensor assembly 86 is attached to the lower end 112 of the drop portion 108A, 108B of the radar support structure 84. As such, the radar sensor assembly 86 is vertically spaced a distance below or beneath the cantilevered portion 100A, 100B of the radar support structure 84. The radar support structure 84 positions the radar sensor assembly 86 forward of the basecutter assembly 36 as described above. The drop portion 108A, 108B of the radar support structure 84 positions the radar sensor assembly 86 below the boom 48 of the topper assembly 28. In one example implementation, the drop portion 108A, 108B of the radar support structure 84 is formed to position the radar sensor assembly 86 directly below the boom 48, in-line with the central longitudinal axis 24 of the frame. However, in other implementations, the drop portion 108A, 108B may position the radar sensor assembly 86 slightly offset from the boom 48 in a lateral direction.

In the example implementation shown in the Figures, the cantilevered portion 100A, 100B includes a first side cantilevered portion 100A disposed on a first lateral side 114 of the central longitudinal axis 24, and a second side cantilevered portion 100B disposed on a second lateral side 116 of the central longitudinal axis 24. As such, the first side cantilevered portion 100A is laterally offset relative to and away from the boom 48 on a first lateral side 114 of the sugarcane harvester 20, e.g., a left side, and the second side cantilevered portion 100B is laterally offset relative to and away from the boom 48 on a second lateral side 116 of the sugarcane harvester 20, e.g., a right side. The boom 48 of the topper assembly 28 is disposed between the first side cantilever portion and the second side cantilevered portion 100B.

In the example implementation shown in the Figures, the drop portion 108A, 108B includes a first side drop portion 108A disposed on the first lateral side 114 of the central longitudinal axis 24, and a second side drop portion 108B disposed on the second lateral side 116 of the central longitudinal axis 24. As such, the first side drop portion 108A is laterally offset relative to and away from the boom 48 on the first lateral side 114 of the sugarcane harvester 20, e.g., the left side, and the second side drop portion 108B is laterally offset relative to and away from the boom 48 on the second lateral side 116 of the sugarcane harvester 20, e.g., the right side. The boom 48 of the topper assembly 28 is disposed between the first side drop portion 108A and the second side drop portion 108B. The first side drop portion 108A and the second side drop portion 108B of the radar support structure 84 position the radar sensor assembly 86 directly below the boom 48 of the topper assembly 28 in-line with the central longitudinal axis 24 of the frame. As such, the first side drop portion 108A and the second side drop portion 108B may be formed, angled, bent, or otherwise configured to transition from the laterally offset position of the cantilevered portion 100A, 100B, inward and/or inboard toward the central longitudinal axis 24 of the frame, to position the radar sensor assembly 86 below the boom 48.

While the example implementation of the radar support structure 84 shown in the Figures includes the first side cantilevered portion 100A and the first side drop portion 108A on the first lateral side 114 of the sugarcane harvester 20, and the second side cantilevered portion 100B and the second side drop portion 108B on the second lateral side 116 of the sugarcane harvester 20, it should be appreciated that other implementations may include structure on only one side of the boom 48, i.e., only the first side cantilevered portion 100A and the first side drop portion 108A, or only the second side cantilevered portion 100B and the second side drop portion 108B.

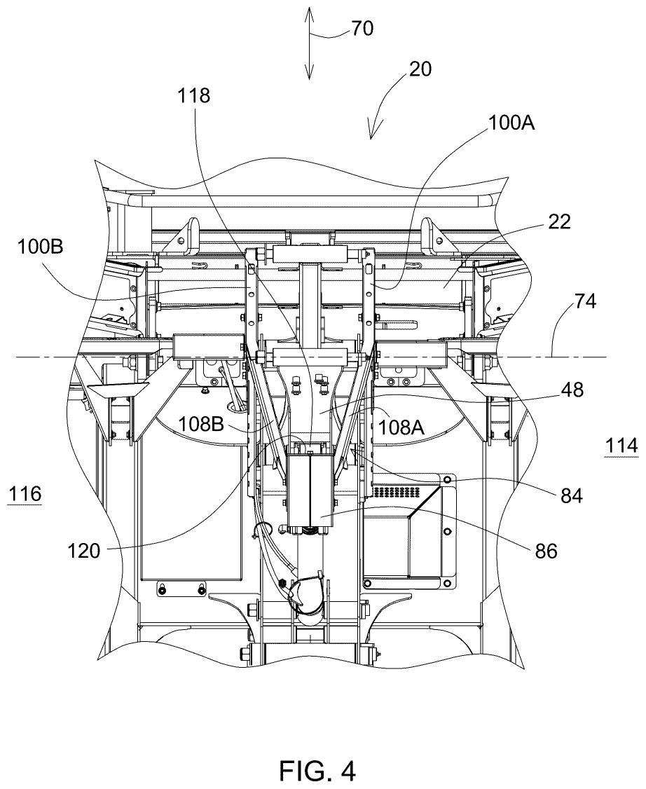

Referring to FIGS. 2 and 4, in the example implementation of the radar support structure 84 shown in the Figures, the radar support structure 84 forms a notch 118. The notch 118 is formed between the first side drop portion 108A and the second side drop portion 108B. The notch 118 is open from above, between the first side cantilevered portion 100A and the second side cantilevered portion 100B. The notch 118 is closed at a lower end 112 thereof. The radar support structure 84 positions the radar sensor assembly 86 at a vertex 120 of the notch 118 below the boom 48. The notch 118 is aligned along the central longitudinal axis 24 of the frame, with the boom 48 positioned within and extending through the notch 118 and with the radar sensor assembly 86 positioned below the boom 48.

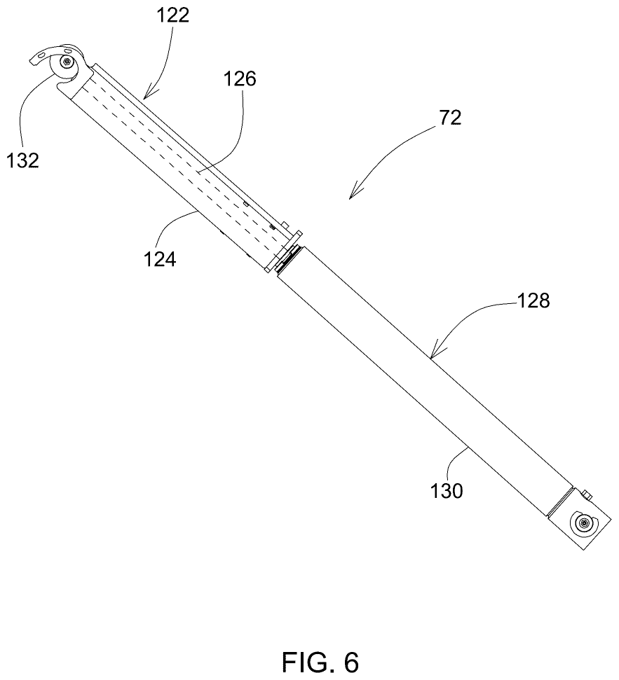

As described above, the boom 48 may be moveable relative to the radar support structure 84, between the left side cantilevered portion 100A, 100B and the right side cantilevered portion 100A, 100B thereof, and between the first side drop portion 108A and the second side drop portion 108B thereof. The boom 48 is moveable through a range of motion, between the lower elevation limit and the upper elevation limit. In some implementations, it is contemplated that the radar sensor assembly 86 may interfere with movement of the boom 48 into the lower elevation limit. In order to prevent damage to the radar sensor assembly 86, the sugarcane a harvester may include a stop 122 blocking movement of the boom 48 prior to contacting the radar sensor assembly 86, thereby preventing movement of the boom 48 fully into the lower elevation limit. As described above, the vertical position of the boom 48 may be controlled by the topper actuator 72, comprised of a double acting hydraulic cylinder 128, which is configured to retract to lower the boom 48. Referring to FIG. 6, in one implementation, the stop 122 may include a bracket 124 partially encircling a rod 126 of the hydraulic cylinder 128, and disposed between a housing 130 of the hydraulic cylinder 128 and a rod end cap 132 of the hydraulic cylinder 128. The stop 122 prevents full retraction of the rod 126 into the housing 130 of the hydraulic cylinder 128, becoming wedged between the rod end cap 132 and the housing 130, thereby limiting the stroke of the hydraulic cylinder 128 and preventing the hydraulic cylinder 128 from lowering the boom 48 into contact with the radar sensor assembly 86. It should be appreciated that the stop 122 may be configured differently than the example implementation described herein, and that the configuration of the stop 122 is dependent upon the type and operation of the topper actuator 72.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A sugarcane harvester comprising:
a main frame extending along a central longitudinal axis between a forward end and a rearward end;
a basecutter assembly having a cutter blade configured to sever a sugarcane stalk portion of a sugarcane plant from a root portion of the sugarcane plant adjacent a ground surface;
a topper assembly including a boom mounted to the main frame and a top cutter attached to and supported by the boom proximate a distal end of the boom, wherein the top cutter is positioned for severing an upper leaf portion of the sugarcane plant from the stalk portion of the sugarcane plant;
a radar support structure including a cantilevered portion having a first end attached to the main frame and extending generally horizontally in the forward direction to a second end;
wherein the radar support structure includes a drop portion having an upper end attached to the second end of the cantilevered portion and extending generally vertically in a downward direction toward the ground surface to a lower end; and
a radar sensor assembly attached to the lower end of the drop portion of the radar support structure and positioned forward of the basecutter assembly.

2. The sugarcane harvester set forth in claim 1, wherein the cantilevered portion of the radar support structure is laterally offset from the boom of the topper assembly relative to the central longitudinal axis of the main frame.

3. The sugarcane harvester set forth in claim 2, wherein the first end of the cantilevered portion of the radar support structure and a mounting end of the boom are positioned at approximately the same elevation relative to the ground surface, whereby the cantilevered portion of the radar assembly is positioned to not interfere with incoming stalk portions of the sugarcane plant.

4. The sugarcane harvester set forth in claim 2, wherein the drop portion of the radar support structure positions the radar sensor assembly directly below the boom of the topper assembly in-line with the central longitudinal axis of the frame.

5. The sugarcane harvester set forth in claim 4, wherein the boom is moveable relative to the cantilevered portion of the radar support structure through a range of motion between a lower elevation limit and an upper elevation limit.

6. The sugarcane harvester set forth in claim 5, further comprising a stop blocking movement of the boom prior to contacting the radar sensor assembly.

7. The sugarcane harvester set forth in claim 1, wherein the cantilevered portion includes a first side cantilevered portion disposed on a first lateral side of the central longitudinal axis, and a second side cantilevered portion disposed on a second lateral side of the central longitudinal axis.

8. The sugarcane harvester set forth in claim 7, wherein the boom of the topper assembly is disposed between the first side cantilever portion and the second side cantilevered portion.

9. The sugarcane harvester set forth in claim 8, wherein the drop portion includes a first side drop portion disposed on the first lateral side of the central longitudinal axis, and a second side drop portion disposed on the second lateral side of the central longitudinal axis.

10. The sugarcane harvester set forth in claim 9, wherein the radar support structure forms a notch, aligned along the central longitudinal axis of the frame, with the boom positioned within the notch and with the radar sensor assembly positioned below the boom.

11. The sugarcane harvester set forth in claim 9, wherein the first side drop portion and the second side drop portion of the radar support structure position the radar sensor assembly directly below the boom of the topper assembly in-line with the central longitudinal axis of the frame.

12. The sugarcane harvester set forth in claim 11, wherein the boom is moveable relative to the radar support structure through a range of motion between a lower elevation limit and an upper elevation limit, between the first side cantilevered portion and the second side cantilevered portion, and between the first side drop portion and the second side drop portion.

13. The sugarcane harvester set forth in claim 12, further comprising a stop blocking movement of the boom prior to contacting the radar sensor assembly.

14. The sugarcane harvester set forth in claim 1, wherein the radar sensor assembly is configured for detecting data related to an elevation of the ground surface.

15. The sugarcane harvester set forth in claim 14, further comprising a controller including a processor and a memory having a basecutter control algorithm stored, thereon, wherein the controller is operable to execute the basecutter control algorithm to control a height of the basecutter assembly relative to the ground surface based on the data sensed by the radar sensor assembly.

16. A sugarcane harvester comprising:
a main frame extending along a central longitudinal axis between a forward end and a rearward end;
a basecutter assembly having a cutter blade configured to sever a sugarcane stalk portion of a sugarcane plant from a root portion of the sugarcane plant adjacent a ground surface;
a topper assembly including a boom mounted to the main frame and a top cutter attached to and supported by the boom proximate a distal end of the boom, wherein the top cutter is positioned for severing an upper leaf portion of the sugarcane plant from the stalk portion of the sugarcane plant;
a radar support structure including a cantilevered portion having a first end attached to the main frame and extending generally horizontally in the forward direction to a second end;
wherein the radar support structure includes a drop portion having an upper end attached to the second end of the cantilevered portion and extending generally vertically in a downward direction toward the ground surface to a lower end;
a radar sensor assembly attached to the lower end of the drop portion of the radar support structure and positioned forward of the basecutter assembly; and
wherein the radar support structure forms a notch, aligned along the central longitudinal axis of the frame, with the boom positioned within the notch and with the radar sensor assembly positioned below the boom.

17. The sugarcane harvester set forth in claim 16, wherein the cantilevered portion includes a first side cantilevered portion disposed on a first lateral side of the central longitudinal axis, and a second side cantilevered portion disposed on a second lateral side of the central longitudinal axis.

18. The sugarcane harvester set forth in claim 17, wherein the boom of the topper assembly is disposed between the first side cantilever portion and the second side cantilevered portion.

19. The sugarcane harvester set forth in claim 18, wherein the drop portion includes a first side drop portion disposed on the first lateral side of the central longitudinal axis, and a second side drop portion disposed on the second lateral side of the central longitudinal axis.

20. The sugarcane harvester set forth in claim 16, wherein the boom of the topper assembly is moveable within the notch formed by the radar support structure.
